(19) United States
(12) Patent Application Publication
(10) Pub. No.: US 2005/0014534 A1
(43) Pub. Date: Jan. 20, 2005

(54) Wireless accessory unit for notification of incoming calls and method of alerting a user to an incoming call

(76) Inventors: Michael D. Hareng, Lake In The Hills, IL (US); Herve J. Cantave, Gurnee, IL (US)

Correspondence Address: POSZ & BETHARDS, PLC, 11250 ROGER BACON DRIVE, SUITE 10, RESTON, VA, 20190, US

(21) Appl. No.: 10/621,480

(22) Filed: Jul. 15, 2003

(51) Int. Cl. H04M 1/00

(52) U.S. Cl. 455/567; 455/575.6; 455/566

(57) ABSTRACT

A system, accessory unit and corresponding method for notifying a user of a wireless communication device (316) of an incoming call where the accessory unit (100) is coupled to a wristwatch (310) such that a display (102) covers the face (315) of the wristwatch (310). The accessory unit (100) includes a transparent liquid crystal display (102), which permits the time to be read from the face (315) of the wristwatch (310) when the accessory device (100) is coupled to the wristwatch (310). Low-power, short-range communication is employed to establish a communication link between the accessory unit (100) and the wireless communication device (316). When an incoming call is received, the wireless communication device (316) sends caller ID information to the accessory unit (100), and the caller ID information is displayed by the accessory unit (100).

### FIELD OF THE INVENTION

This invention relates in general to wireless communication devices, and more specifically to an accessory unit for alerting a user to an incoming call received by a separate, linked, wireless communication device.

### BACKGROUND OF THE INVENTION

Many users of portable wireless communication devices, such as cellular handsets, store their phones in a bag or in a desk. This may cause the user to miss a call, since the ringer may not be audible. Also, some users of cellular handsets must keep their handsets in a quiet mode while, for example, attending a meeting. These users sometimes miss calls. Similarly, a user may miss a call when temporarily away from his or her handset.

Many cellular handsets sold currently advertise the ability to communicate with other devices, such as headsets, using the Bluetooth standard. However, there are relatively few devices available that take advantage of the ability to communicate with cellular handsets.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 is a plan view of an exemplary accessory unit;

FIG. 2 is a side view of the accessory unit of FIG. 1;

FIG. 3 is a side view of the accessory unit of FIG. 1 while the accessory unit is coupled to a wristwatch;

FIG. 4 is an exemplary schematic diagram illustrating the interconnection of various internal parts of the accessory unit of FIG. 1; and

FIG. 5 is an exemplary block diagram of a wireless communication device that is linked to the accessory unit of FIG. 1.

### DETAILED DESCRIPTION OF PREFERRED EMBODIMENTS

The present disclosure concerns communications systems that provide services such as voice and data communications services to communications devices or units, often referred to as subscriber devices, such as cellular phones, two-way radios, personal digital assistants and the like.

More particularly various inventive concepts and principles embodied in an incoming call alert system, which includes an accessory unit for notifying a user of incoming calls to or for a wireless communication device, are discussed. The wireless communication device can be any of a variety of wireless communication devices, such as a cellular handsets or equivalents thereof.

The communication devices that are of particular interest are those that provide or facilitate voice communication services or data or messaging services, such as conventional two way systems and devices, various cellular phone systems including analog and digital cellular, CDMA (code division multiple access) and variants thereof, GSM (Global System for Mobile Communication), GPRS (General Packet Radio System), 2.5 G and 3G systems such as UMTS (Universal Mobile Telecommunication Service) systems, integrated digital enhanced networks, and variants or evolutions thereof. Similarly, the communication systems and devices can include LAN (local area network) systems that employ anyone of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures.

As further discussed below various inventive principles and combinations thereof are advantageously employed to provide an accessory unit, an incoming call alert system, and a method for alerting a user to an incoming call, thus alleviating various problems associated with known wireless communication devices provided these principles or equivalents thereof are employed.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, upper and lower and the like are used solely to distinguish one from another entity or action without necessarily requiring or implying any actual such relationship or order between such entities or actions.

The terms “a” or “an” as used herein are defined as one or more than one. The term “plurality” as used herein is defined as two or more than two. The term “another” as used herein is defined as at least a second or more. The terms “including,” “having” and “has” as used herein are defined as comprising (i.e., open language). The term “coupled” as used herein is defined as connected, although not necessarily directly and not necessarily mechanically.

Much of the inventive functionality and many of the inventive principles are best implemented with or in structural arrangements and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such structural arrangements and ICs with minimal experimentation. Therefore, in the interest of brevity and minimization of any risk of obscuring the principles and concepts according to the present invention, further discussion of such structural arrangements and ICs, if any, will be limited to the essentials with respect to the principles and concepts used by the preferred embodiments.

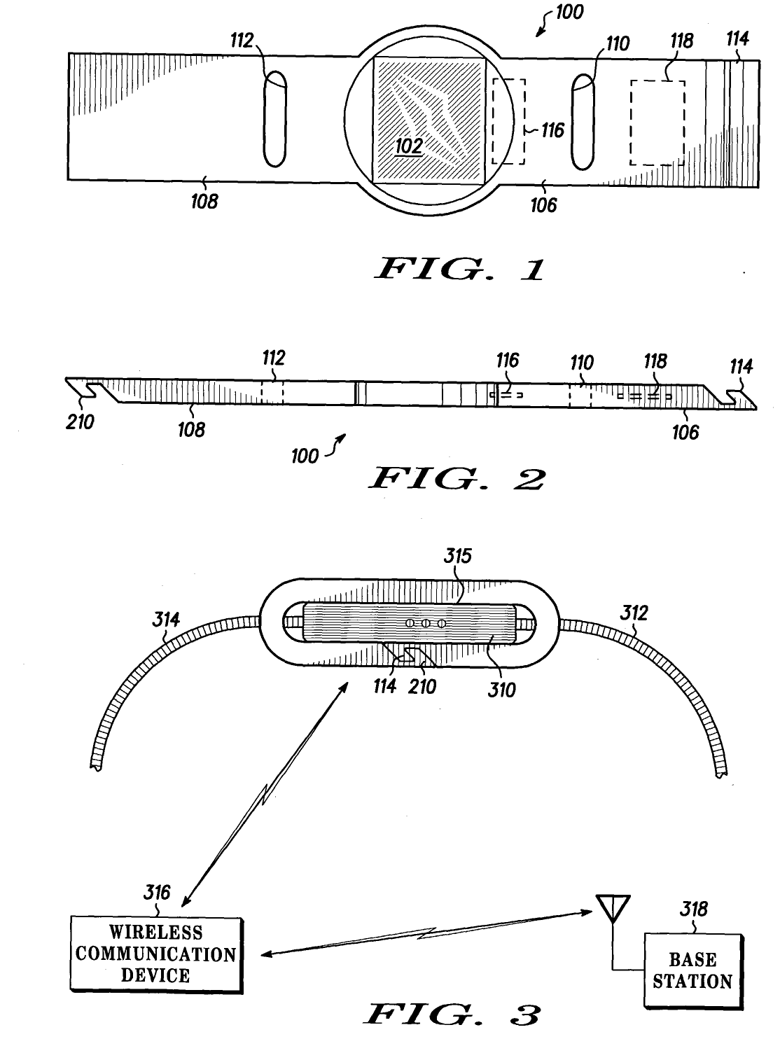

Basically, as shown in FIG. 1 and FIG. 2, the present disclosure concerns an accessory unit 100 for alerting a user to the existence of an incoming call that has been received by an associated wireless communication device 316 (see FIG. 3). The accessory unit 100 includes a first strap 106 and a second strap 108. The accessory unit includes a coupler 110, 112, 114, 210 for coupling the accessory unit to a wristwatch 310. In the illustrated embodiment, the coupler includes a first hook 114, which is located at an end of the first strap 106, and a second hook 210, which is located at an end of the second strap 108. A first opening 110 is formed in the first strap 106. A second opening 112 is formed in the second strap 108. The straps are made of flexible material such as plastic. The straps 106, 108 may be reinforced with strong flexible material, such as flexible metal bands, embedded in the straps 106, 108.

As shown in FIG. 3, a first watch strap 312 passes through the first opening 110 and a second watch strap 314 passes through the second opening 112 to secure the accessory unit 100 to the wristwatch 310. Also, the first hook 114 engages the second hook 210 at the back of the wristwatch 310 as shown. Any known coupling device can serve as the coupler to secure the accessory unit 100 to the wristwatch 310. For example, Velcro straps may be employed instead of the interlocking hooks. Also, clamping members fixed to the accessory unit 100 may grip the wristwatch 310.

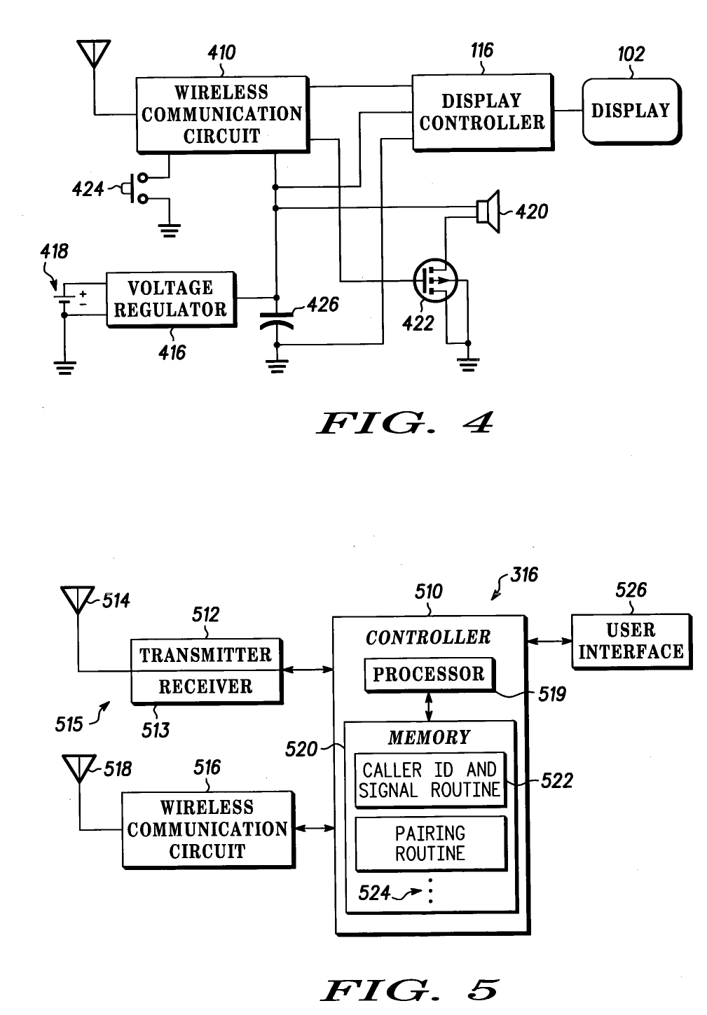

The accessory unit 100 includes an alerting device 102, 420 (420 is depicted in FIG. 4 and referred to as a speaker below) for signaling the user when a call is received by the associated wireless communication device 316. In the preferred embodiment, the alerting device 102, 420 includes, specifically, a visual display 102 and a speaker 420. Either of the speaker 420 and the display 102 may be deactivated, so that the user may choose among a visual notification, an audible notification or both.

The display 102 is generally planar and is secured to the first and second straps 106, 108 by molding or other conventional methods. The display 102 covers and is generally parallel to a face 315 of the wristwatch 310 when the accessory unit 100 is coupled to the wristwatch 310. The display 102 is preferably a conventional, commercially available liquid crystal display (LCD). LCD displays are well known and will not be described in detail. A typical LCD employs a reflector at a back side of the display to provide a surface that creates uniform contrast behind the displayed characters. However, no reflector is provided in the display 102 of the preferred embodiment. The face 315 of the wristwatch 310 provides a background for the display 102. The display 102 is transparent, and characters appear on the display 102 when segments of the display 102 are darkened. Thus, if no characters are displayed, the display 102 is simply a transparent window through which a user can view the face 315 of the wristwatch 310. If the wristwatch 310 has a light for illuminating the face 315, the light can serve as a backlight for the display 102, but a backlight is not required. Even if characters appear on the display 102, the characters will most likely not significantly interfere with the user's view of the face 315 of the wristwatch 310. Therefore, the accessory unit 100 does not interfere with the normal function of the wristwatch 310. The visual signal is preferably a display of caller ID information but may be a flashing symbol or other visual notification. The characters of the caller ID information may be flashing or moving to draw the user's attention. The time during which notification information is displayed on the display 102 is preferably limited to conserve battery strength.

Although not shown in FIG. 1, the accessory unit 100 includes a speaker 420 for producing an audible signal when a call is received by the associated wireless communication device 316. The speaker 420 is illustrated schematically in FIG. 4.

Embedded in the first strap 106 is a printed circuit board (PCB) 118 for carrying most of the internal electrical parts of the accessory unit 100. One of the parts on the PCB 118 is a wireless communication circuit 410 for establishing a wireless link with the wireless communication device 316. The wireless communication circuit 410 is shown schematically in FIG. 4. The wireless communication circuit 410 is preferably a commercially available circuit module that communicates in conformance with a technical standard commonly known as Bluetooth. However, alternatively, other low-power, short-range communication circuits following other standards may be used. The Bluetooth standard is preferred since it is a short-range, low-power standard being employed in many cellular handsets and other devices currently being sold.

A display controller circuit 116 is also embedded within the first strap 106. The display controller circuit 116 is a conventional circuit for driving the display 102.

The display controller circuit 116 is electrically coupled to the wireless communication circuit 410, and the display controller circuit 116 receives signals from the wireless communication circuit 410 and controls the display 102 in accordance with the signals from the wireless communication circuit 410. That is, when the wireless communication circuit 410 receives caller ID information, the digits of the source telephone number or the name of the caller are displayed on the display 102 in the same manner that such information is currently displayed on the screens of conventional cellular handsets. The details of how information received through a wireless link is transferred to the display 102 are well within the knowledge of one of ordinary skill in the art.

Referring to FIG. 4, the wireless communication circuit 410, the display controller circuit 116, and the speaker 420 are powered by a battery 418. The battery is preferably located on the PCB 118. A door (not shown) is provided in the first strap 106 for permitting the battery to be changed in a conventional manner. The PCB 118 also includes a voltage regulator 416 and a capacitor 426. The capacitor 426 serves to stabilize the voltage applied to the various components in a conventional manner.

A transistor 422 is provided to control the speaker 420 in a conventional manner. That is, audio signals from the wireless communication circuit 410 cause the transistor to drive the speaker 420 and thus operate the speaker 420. Therefore, the wireless communication circuit 410 controls the speaker 420. The transistor 422 is preferably mounted on the PCB 118. The speaker 420 may be mounted on the PCB 118. Alternatively, the speaker 420 may be located elsewhere on the accessory unit 100 and electrically coupled to the wireless communication circuit 410.

A switch 424 is connected to the wireless communication circuit 410. The switch 424 serves to turn off the power to the accessory unit 100 and it may serve other functions according to software programming within the wireless communication circuit 410. For example, the switch 424 may be pressed for a predetermined length of time to put the accessory unit 100 in a pairing state, which is described later. The switch 424 is located on the accessory unit 100 in a position where it can be easily operated by a user; however, the switch 424 is not illustrated in FIG. 1 or FIG. 2. The switch 424 is preferably located on the PCB 118 but may be located elsewhere and electrically coupled to the PCB 118.

FIG. 5 shows a wireless communication device 316, which is a cellular handset in the preferred embodiment. The wireless communication device 316 includes a primary wireless communication circuit 515 and a secondary wireless communication circuit 516. The primary wireless communication circuit 515 includes a transmitter 512, a receiver 513, and an antenna 514. The primary wireless communication circuit 515 is for normal voice and/or data communications performed by the wireless communication device 316. The primary wireless communication circuit 515 communicates with a base station 318 in a well known manner for connecting the wireless communication device 316 to a subscriber network.

The secondary wireless communication circuit 516 is for establishing a wireless link with the wireless communication circuit 410 of the accessory unit 100. The secondary wireless communication circuit 516 includes an antenna 518 and is preferably a circuit that communicates in conformance with the Bluetooth standard or any other short range wireless communications protocol. The secondary wireless communication circuit 516 may be a commercially available circuit module, for example. The wireless communication device 316 includes a controller 510, which includes a processor 519 and a memory 520. The memory 520 stores, among others, an operating system or routines 524 for controlling and operating the wireless communication device 316 and a caller ID and signal routine 522 for sending caller ID information to the accessory unit 100 when a call is received. This routine 522 can be used to gather the caller ID information that is normally displayed on the screen of cellular handsets and send it to the accessory unit 100 through the secondary wireless communication circuit 516 when an incoming call is received. Other information that is normally displayed on the screen of cellular handsets, such as signal strength and message icons may also be transmitted to the accessory unit 100 and displayed by the accessory unit 100 in the same manner.

The accessory unit 100 operates exclusively with the associated wireless communication device 316 as a result of a pairing operation. This operation is well known to those of ordinary skill in the art and is thus not described in detail. To initiate pairing, the user typically selects a menu item with a name such as “device discovery” on the cellular handset with a user interface 526, which starts a pairing routine. The pairing routine will typically require that both the remote device, which is the accessory unit 100 in this case, and the wireless communication device 316 be in a pairing state. Thus, in this case, the accessory unit 100 must be placed in the pairing state by, for example, pressing the switch 424 for a predetermined period of time. Also, it may be required to enter a password at the wireless communication device 316 to permit pairing. The pairing routine will then establish a wireless link with the accessory unit 100, and other nearby devices using the same communication standard will not interfere. After pairing is performed, it need not be performed again unless a different device is to be linked to the wireless communication device 316. That is, a wireless link is automatically established each time the wireless communication device 316 and the accessory unit 100 are both activated and within range of one another.

Operation of the accessory unit 100 entails coupling the accessory unit 100 to a wristwatch 310, and establishing a wireless link between the accessory unit 100 and a wireless communication device 316. When a call is received by the wireless communication device 316, the user of the accessory unit 100 is alerted that the call has been received with the accessory unit 100. The operation further includes locating a display 102 over a face of the wristwatch 310 and displaying caller identification information on the accessory unit 100 to identify the source of the call when the wireless communication device 316 receives a call. The operation may include producing an audible signal with the accessory unit 100 when the wireless communication device 316 receives a call. The operation includes providing a transparent display 102 over the face of the wristwatch 310, so that a user can read the time from the wristwatch 310 when the accessory unit 100 is coupled to the wristwatch 310.

The apparatus and methods discussed above and the inventive principles thereof are intended to and can alleviate problems with conventional wireless communication devices. Using these principles of incoming call notification will contribute to user satisfaction. It is expected that one of ordinary skill given the above described principles, concepts, and examples will be able to implement other alternative procedures and constructions that offer the same or equivalent benefits. It is anticipated that the claims below cover many such other examples. For example, accessory unit 100 may be connected to the wristwatch 310 by means other than the interlocking straps 106, 108. Also, the accessory unit 100 may be adapted to display information other than caller ID information, such as the current signal strength of the associated wireless communication device 316. Further, although it is described that the display 102 is transparent and the characters are formed by darkened segments, the display 102 may be normally dark, and characters may be formed by transparent segments. In addition, although notifications are described as being visual or audible, a tactile notification may be used to notify the user of an incoming call. For example, a small vibrator may be included in the accessory unit 100.

The disclosure is intended to explain how to fashion and use various embodiments in accordance with the invention rather than to limit the true, intended and fair scope and spirit thereof. The forgoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. An accessory unit for alerting a user of an incoming call received by an associated wireless communication device, the accessory unit comprising:
a coupler configured to couple the accessory unit to a wristwatch;
a wireless communication circuit configured to wirelessly receive information from the wireless communication device; and
an alerting device configured to signal the user when a call is received by the wireless communication device.

2. An accessory unit according to claim 1, wherein the alerting device includes a display, which is normally transparent, and the display is located over a face of the wristwatch, and wherein the display permits the user to see the face of the wristwatch through the display when the accessory unit is coupled to the wristwatch.

3. An accessory unit according to claim 2, wherein the display is generally planar, and the display covers and is generally parallel to the face of the wristwatch when the accessory unit is coupled to the wristwatch.

4. An accessory unit according to claim 2, wherein the display is a liquid crystal display.

5. An accessory unit according to claim 1, wherein the alerting device includes a speaker for producing an audible signal when a call is received by the wireless communication device.

6. An accessory unit according to claim 1, wherein the accessory unit displays identification information to identify the source of the call.

7. An accessory unit according to claim 1, wherein the accessory unit includes a printed circuit board, which carries the wireless communication circuit, and a battery.

8. An incoming call alert system comprising:
a wireless communication device, wherein the wireless communication device includes a primary wireless communication circuit and a secondary wireless communication circuit; and
an accessory unit configured to alert a user of an incoming call at the primary wireless communication circuit of the wireless communication device, wherein the accessory unit includes:
a coupler configured to couple the accessory unit to a wristwatch;
a wireless communication circuit wirelessly coupled to the secondary wireless communication circuit of the wireless communication device; and
an alerting device configured to signal a user when a call is being received by the primary wireless communication circuit of the wireless communication device.

9. An incoming call alert system according to claim 8, wherein the alerting device includes a display, which is normally transparent, and the display is located over a face of the wristwatch, and wherein the display permits the user to see the face of the wristwatch through the display when the accessory unit is coupled to the wristwatch.

10. An incoming call alert system according to claim 9, wherein the display is generally planar, and the display covers and is generally parallel to the face of the wristwatch when the accessory unit is coupled to the wristwatch.

11. An incoming call alert system according to claim 9, wherein the display is a liquid crystal display.

12. An incoming call alert system according to claim 8, wherein the alerting device includes a speaker for producing an audible signal when a call is received by the wireless communication device.

13. An incoming call alert system according to claim 8, wherein the accessory unit displays identification information to identify the source of the call.

14. An incoming call alert system according to claim 8, wherein the accessory unit includes a battery and a printed circuit board further including the wireless communication circuit.

15. An incoming call alert system according to claim 8, wherein the wireless communication device wirelessly transmits caller identification information to the accessory unit when a call is received by the primary wireless communication circuit to identify the source of the call to a user of the accessory unit.

16. A method for alerting a user of an incoming call, wherein the method comprises:
coupling an accessory unit to a wristwatch;
establishing a wireless link between the accessory unit and a wireless communication device; and
alerting a user that a call is being received with the accessory unit when the call is being received by the wireless communication device.

17. A method according to claim 16, wherein the method includes locating a display over a face of the wristwatch.

18. A method according to claim 16, wherein the method includes displaying caller identification information on the accessory device to identify the source of the call when a call is received by the wireless communication device.

19. A method according to claim 16, wherein the method includes producing an audible signal with the accessory unit when a call is received by the wireless communication device.

20. A method according to claim 16, wherein the method includes providing a transparent display over a face of the wristwatch, so that a user can read the time from the wristwatch when the accessory unit is coupled to the wristwatch.
